(19) United States
(12) Patent Application Publication
(10) Pub. No.: US 2017/0023192 A1
(43) Pub. Date: Jan. 26, 2017

(54) BODY WITH ENCLOSED LIGHTS

(71) Applicant: Jose M MOITA, Edmonton (CA)

(72) Inventor: Jose M MOITA, Edmonton (CA)

(21) Appl. No.: 15/051,441

(22) Filed: Feb. 23, 2016

(30) Foreign Application Priority Data
Feb. 24, 2015 (CA) 2882994

(51) Int. Cl. F21S 4/22; E01C 11/02; F21S 8/00; E01F 9/582; F21V 3/04; F21V 31/00

(52) U.S. Cl. CPC F21S 4/22; F21V 3/0436; F21V 31/005; F21S 8/032; E01F 9/582; E01C 11/02; F21Y 2103/10

(57) ABSTRACT

There is provided a body having a base made from a flexible material, the base having a plurality of sides and a length, one or more sides having a lighting channel formed in the base and having an opening in the one or more side, the lighting channel being continuous along the length of the base, a lighting cover mounted toward the top of the base that forms an enclosure with the lighting channel, and a linear light source enclosed within the enclosure and extending along at least a portion of the length of the base.

### TECHNICAL FIELD

This relates to a body made from a flexible material having enclosed lights.

### BACKGROUND

It is often desired to illuminate portions of the landscape for decoration, safety, or to designate areas for different purposes. Adding lighting to existing landscape features provides a practical means to achieve these purposes.

### SUMMARY

According to an aspect, there is provided a body comprising a base made from a flexible material, the base having a plurality of sides and a length, one or more sides comprising a lighting channel formed in the base and having an opening in the one or more side, the lighting channel being continuous along the length of the base, a lighting cover mounted toward the top of the base that forms an enclosure with the lighting channel, and a linear light source enclosed within the enclosure and extending along at least a portion of the length of the base.

According to another aspect, the base may have a first end and a second end spaced apart by the length of the base, at least one of the first end and the second end may comprise an opening extending at least a portion of the length of the base.

According to another aspect, the body may further comprising a connector inserted between one base and another base, the connector comprising engagement portions extending from the center of the connector and engaging the opening of each base.

According to another aspect, the connector may further comprise a drainage portion having a first end, a second end, a first side, and a second side, the engagement portions extending from at least one of the first end and the second end of the drainage portion, the drainage portion comprising drainage channels extending between the first side and the second side of the drainage portion.

According to another aspect, one or more sides may comprise an engagement profile that engages a substrate.

According to another aspect, one of the sides may be a bottom and the base portion may comprise attachment openings between the lighting channel and the bottom, the attachment openings receiving spikes.

According to another aspect, the flexible material may be one of rubber and polyvinyl chloride.

According to another aspect, the lighting cover may be constructed from one of a transparent plastic and a translucent plastic.

According to another aspect, the light source may comprise flexible linear LED lights.

According to another aspect, the enclosure may be sealed along the length of the base.

According to an aspect, there is provided an expansion joint for a layer of concrete, the expansion joint comprising a base made from a flexible material, the base having a length, atop, a bottom and opposed sides, the bottom and opposed sides comprising concrete engagement surfaces, a lighting channel formed in the base and having an opening at the top of the base, the lighting channel being continuous along the length of the base, a lighting cover mounted toward the top of the base that forms an enclosure with the lighting channel, and a linear light source enclosed within the enclosure and extending along at least a portion of the length of the body.

According to another aspect, the flexible material may be one of rubber and polyvinyl chloride.

According to another aspect, the lighting cover may be one of a transparent plastic and a translucent plastic.

According to another aspect, the light source may comprise flexible linear LED lights.

According to another aspect, at least one of the opposed sides may comprise an engagement profile that engages the concrete.

According to another aspect, the enclosure may be sealed along the length of the base.

According to an aspect, there is provided a method of providing an expansion joint with a continuous channel for lighting, the method comprising forming a layer of concrete, before the concrete has cured, inserting an expansion joint into the concrete, the expansion joint comprising, a base made from a flexible material, the base having a length, a top, a bottom and opposed sides, the bottom and opposed sides comprising concrete engagement surfaces, a lighting channel formed in the base and having an opening at the top of the base, the lighting channel being continuous along the length of the base, allowing the concrete to cure, inserting a linear light source into the lighting channel, and covering the lighting channel with a lighting cover.

According to another aspect, the flexible material may be one of rubber and polyvinyl chloride.

According to another aspect, the lens may be one of a transparent plastic and a translucent plastic.

According to another aspect, the light source may comprise flexible linear LED lights.

According to another aspect, at least one of the opposed sides may comprise an engagement profile that engages the concrete.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a body with enclosed lights.

FIG. 2 is a cross section view of a body with enclosed lights in a layer of concrete.

FIG. 3a-3d are front elevation views of bodies with enclosed lights having a variety of engagement profiles.

FIG. 4 is a top plan view of two bodies with enclosed lights being connected together.

FIG. 5 is a cross section view of a body having a spike and an attachment opening.

FIG. 6 is a perspective view of an alternate embodiment of the body.

FIG. 7a is a perspective view of a connection piece for an alternate body.

FIG. 7b is a perspective view of the connection piece connected to the body.

FIG. 8 is a side elevation view of an alternate body with a cover for enclosed lights.

FIG. 9 is a perspective view of an alternate body with a cover for enclosed lights.

FIG. 10 is a perspective view of an alternate body having a spike.

FIG. 11a is a side elevation view of an alternate body having a spike.

FIG. 11b is a detailed side elevation view of an alternate body having a spike.

FIG. 12 is a perspective view of an alternate connection piece for the alternate body.

FIG. 13 is a cross section view of the alternate connection piece.

FIG. 14 is a perspective view of the top portion of the alternate connection piece.

FIG. 15 is a perspective view of the bottom portion of the alternate connection piece.

FIG. 16 is a perspective view of the alternate connection piece connected to the body.

FIG. 17a-c are top plan views of a body while straight and with curves.

FIG. 18 is a perspective view of a curved body that is hollow.

FIG. 19 is a perspective view of a curved body that is solid.

FIG. 20 is a cross section view of a body with enclosed lights having a separate platform for use with the spike.

### DETAILED DESCRIPTION

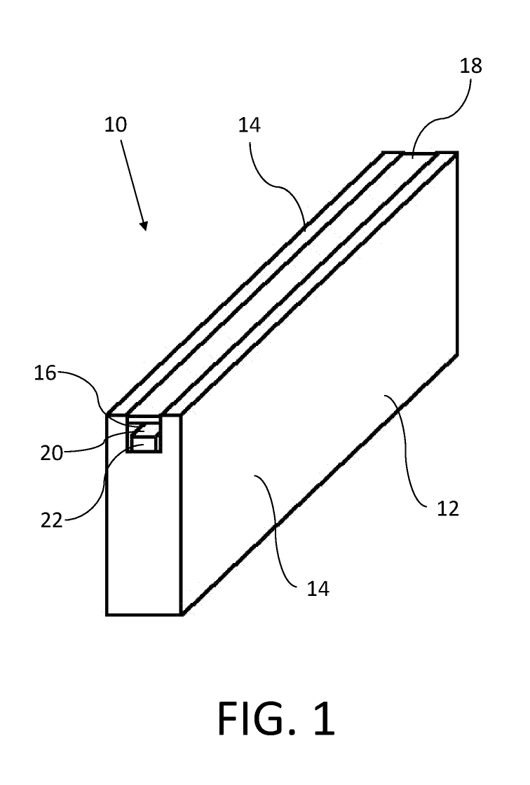

A body generally identified by reference numeral 10, will now be described with reference to FIG. 1 through 5. Body 10 will be described as an expansion joint for use in a layer of concrete. However, it will be understood that body 10 may be used for other purposes, such as edging for landscaping or in surfaces such as driveways or parking lots. Body 10 may also be used in decks, on fascia, on boat docks, on bridges, and with paving stones.

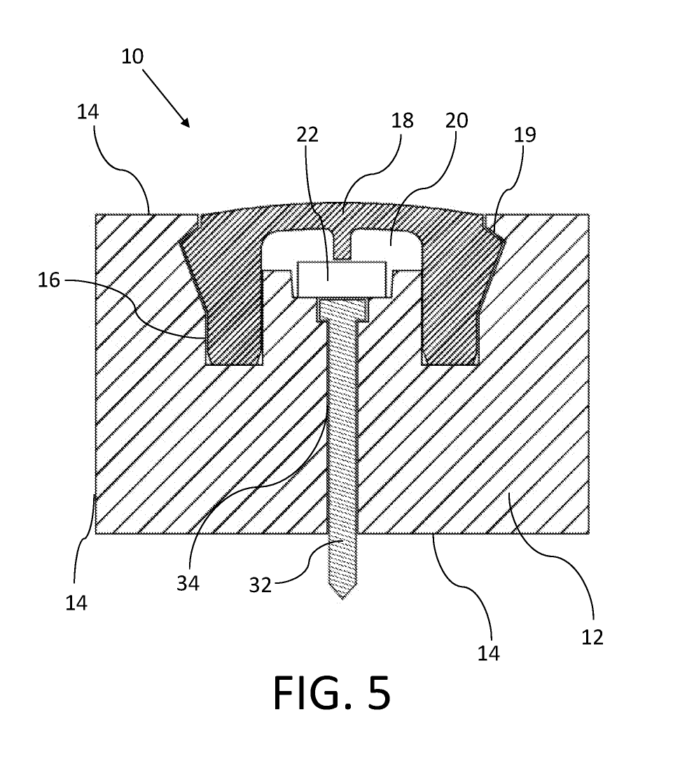

Referring to FIG. 1, body 10 has a base 12 made from a flexible material. The flexible material is preferably rubber, however, as will be understood by those skilled in the art, other flexible materials such as polyvinyl chloride (PVC), plastics, etc. may also be used. Base 12 has a plurality of sides 14, and one or more of sides 14 has alighting channel 16 that is continuous along the length of base 12. In the embodiment shown in FIG. 1, lighting channel 16 is located in the side 14 that is the top of base 12, however, it will be understood that lighting channel 16 may be located on a different side 14 if it is desired to have the light directed towards the side instead of upwards. Towards the top of base 12, the top being the portion of the opening closest to the side 14 that lighting channel 16 is located in, is mounted a lighting cover 18. Lighting channel 16 preferably has a profile that receives and retains lighting cover 18 at the desired position within channel 16. Lighting cover 18 may be engaged by friction fit or by a groove-type profile 19 as shown in FIG. 5. Referring to FIG. 20, lighting cover 18 may also be co-extruded with base 12, creating a sealed engagement between base 12 and lighting cover 18. Lighting cover 18 may be a transparent or a translucent material, or a material that has diffusing, distorting or lensing properties. Lighting cover 18 is preferably made from a suitable plastic material chosen for durability, cost, appearance and ease of handling and installation. It will be understood that other transparent or translucent materials, such as glass or rubber, may be used to form lighting cover 18, depending on the application and preferences of the user. Lighting cover 18 may also be colourless or coloured. Lighting channel 16 and lighting cover 18 form a continuous enclosure 20 in which a linear light source 22 is enclosed and is able to extend from end to end. Linear light source 22 extends along at least a portion of the length of base 12. Linear light source 22 is preferably flexible linear LED lights such as LED rope lights, strip lights, or tape lights. It will be understood that other light sources may be used, and the light sources may be either flexible or rigid, for example, fibre optic lights or neon tube lights, may be used depending on the application and preferences of the user. As the lengths of lights that may be required to extend along the desired length of base 12 may vary, preferably light source 22 is either in a continuous roll that may be cut to a desired length, or is in lengths that can be spliced or connected end-to-end with other lengths of lights. If flexible, lighting cover 18 may also be installed from a continuous roll of material.

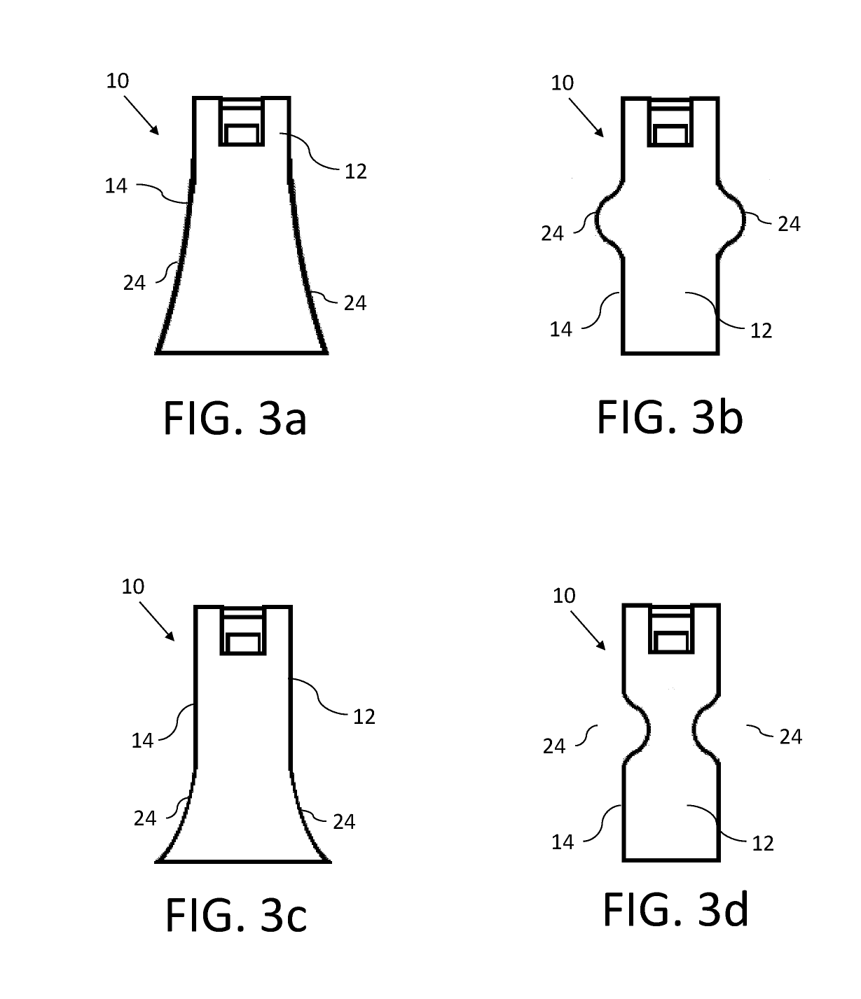

Referring to FIG. 3a through 3d, at least one of the sides 14 of base 12 may have engagement profiles 24 that engage a substrate in which it is embedded, such as concrete or dirt. Engagement profile 24 resists removal of base 12 from the substrate. As seen in FIG. 3, engagement profile 24 may take a variety of shapes. As will be understood by those skilled in the art, the shapes of engagement profile 24 are not limited to those examples seen in FIG. 3. Aside from those shown, engagement profile 24 may be, for example, a jagged saw-toothed edge, a rectangular tab extending from sides 14, an extension that extends upward to form a material-receiving trough, or other profile that may be suitable for a particular application. When body 10 is used in a permeable substrate, such as in soil as landscape edging, or in order to more securely anchor body 10 during construction, body 10 may be attached using spikes 32 as shown in FIG. 5. Body 10 may have attachment openings 34 between lighting channel 16 and the bottom of base 12 that allow spikes to be driven through base 12 and into the substrate. It will be understood that attachment openings 34 may extend through other parts of base 12 or in other directions, such as diagonally or laterally through a bottom portion of base 12, or through engagement profile 24, which may be designed for that purpose.

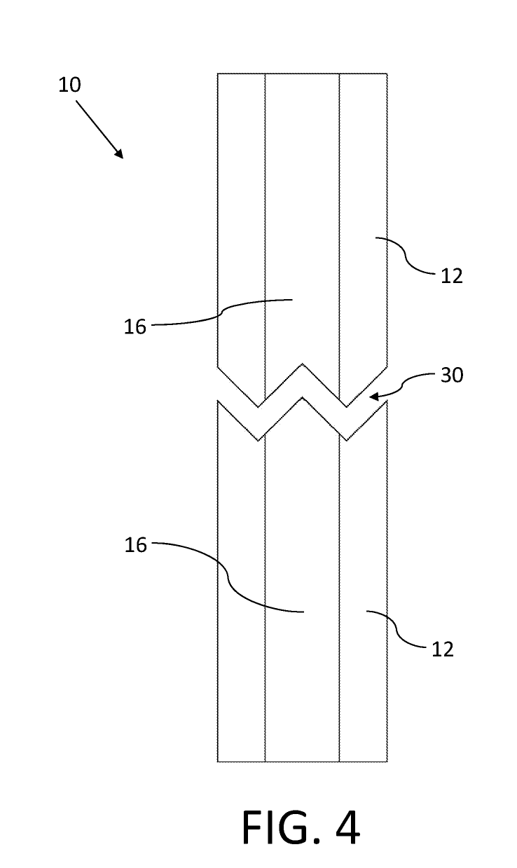

In a preferred embodiment, base 12 is made using a continuous extrusion process. However, as will be understood by one skilled in the art, a variety of methods may be used to form base 12, such as injection moulding. Using an extrusion process permits base 12 to be coiled on a coil that allows a desired length of base 12 to be installed in a unitary length. Base 12 may also be cut or formed into shorter lengths. Referring to FIG. 4, when two or more lengths base 12 are required, base 12 may be provided with a connecting profile 30 on either end. Connecting profile 30 may be a straight connection, or may be an angled connection as shown in FIG. 4 that makes it easier to align the ends of base 12 during installation and resists shifting after installation. Connection profile 30 may also be shaped in other ways depending on the application, as will be understood by one skilled in the art. For example, connection profile 30 may include an overlapping component that allows the adjacent lengths of base 12 to be pin connected, or an interlocking profile that provides a friction or resilient connection. Those skilled in the art will understand that various profiles may be used to achieve the desired level of connection between adjacent lengths.

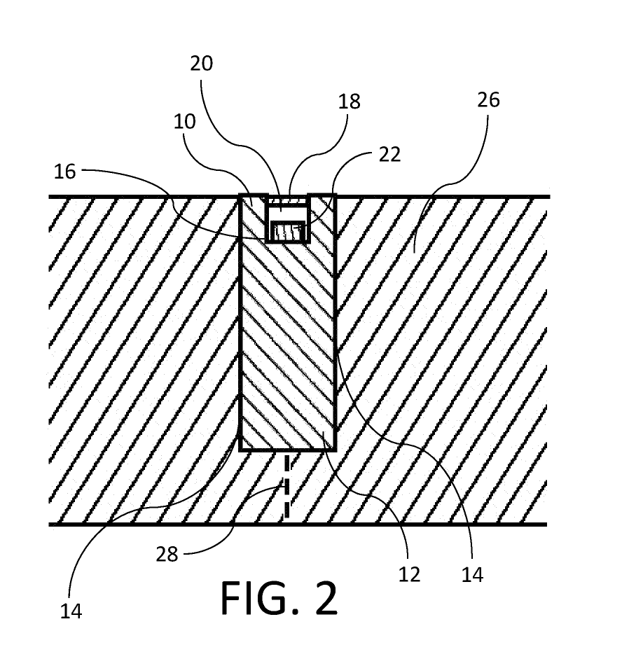

Referring to FIG. 2, body 10 may be used as an expansion joint in a layer of concrete 26. Once layer of concrete 26 is formed, and prior to concrete 26 curing, base 12 is inserted into concrete 26. In a preferred embodiment, concrete 26 is then allowed to cure, although it will be understood that the remaining steps may be completed prior to inserting base 12 into concrete 26, prior to allowing concrete 26 to cure, when concrete 26 is partially cured, or when concrete 26 has cured completely, depending on the requirements of the application, as well known by those skilled in the art. When appropriate, linear light source 22 is inserted into lighting channel 16 and is then covered with lighting cover 18. In some applications lighting cover 18 may be applied first, and linear light source 22 may be fed into enclosure 20 afterwards. Expansion joint 10 will control the effects of expansion and create a weak point 28 in concrete 26 such that when concrete 26 is stressed, it will tend to a predictable manner at weak point 28. It will be understood that different installation methods may be used when body 10 is installed in different substrates.

By using the body 10 with lighting described herein, it is possible to create unique or customized designs in concrete or other landscaping for aesthetic purposes or to communicate information. Lighting controllers, as are known in the art, may also be used with appropriate linear light source 22 to present changing designs, colours or patterns. Depending on the power source and type of controller, it may be necessary to form a cavity (not shown) in base 12 to receive electrical components, such as a controller or transformer. The various ways in which light source 22 may be controlled and connected to a power source will be recognized by those skilled in the art.

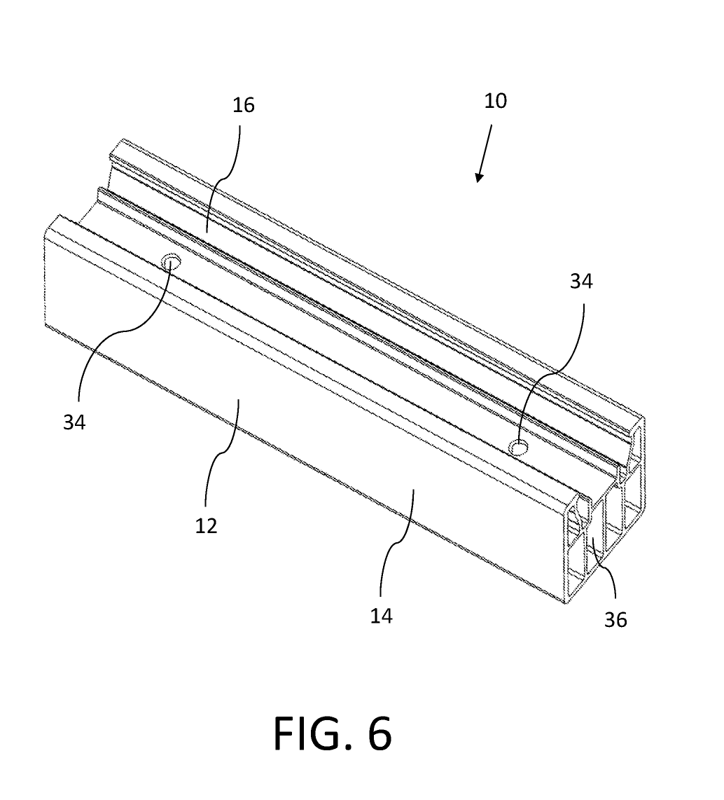

Another embodiment of body 10 will now be described with reference to FIG. 6 through FIG. 16. Body 10 will be described as edging for landscaping. However, it will be understood that body 10 may be used for other purposes, as discussed above. For example, body 10 may be used in surfaces such as driveways or parking lots, as an expansion joint for use in a layer of concrete, in the formation of decks and patios, on fascia, with paving stones, etc. Depending on the intended purpose, the dimensions of body 10, such as the height and depth, may be varied.

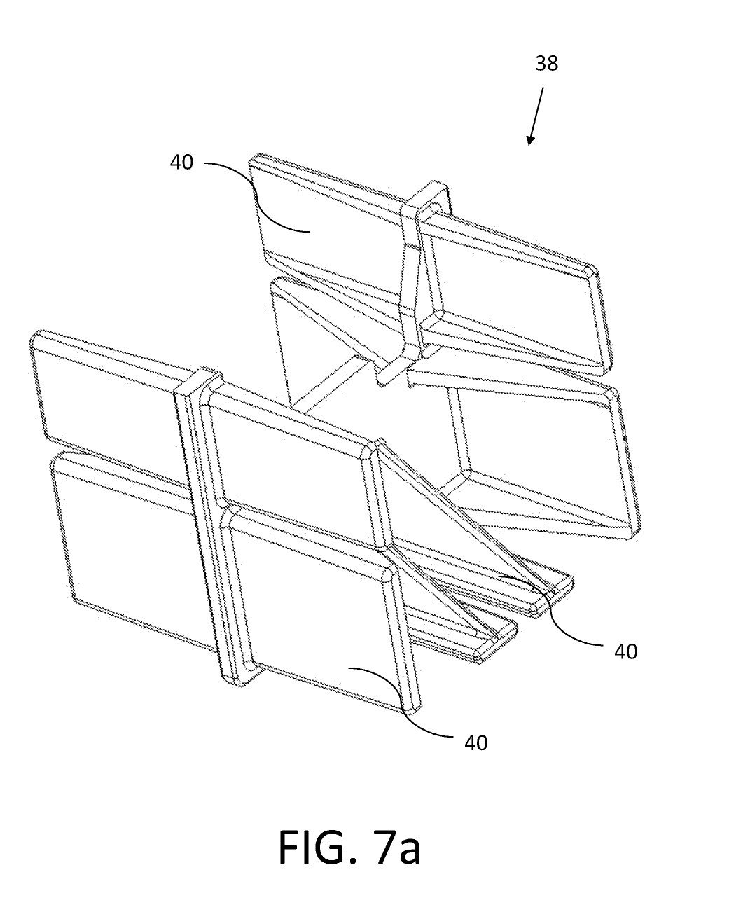

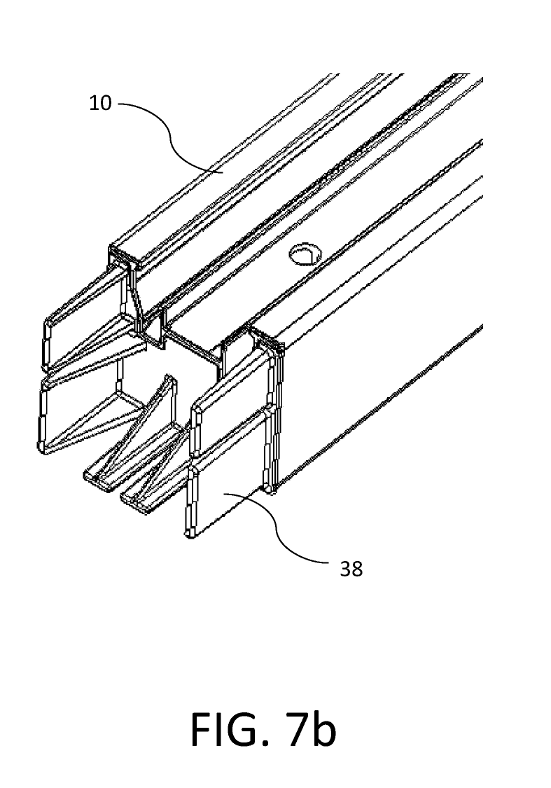

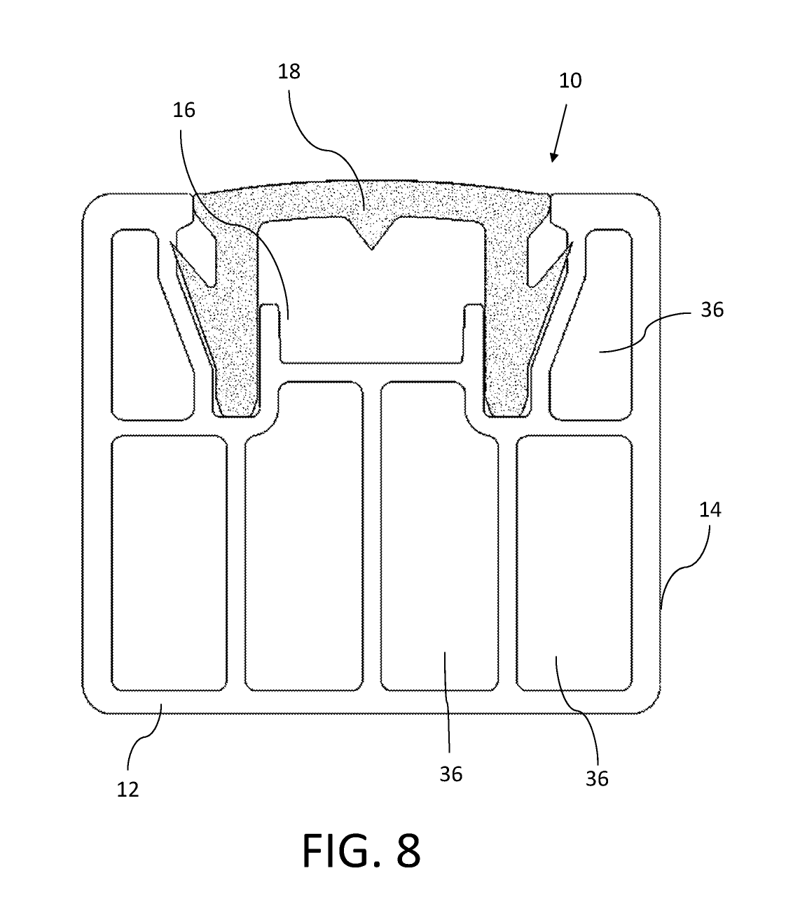

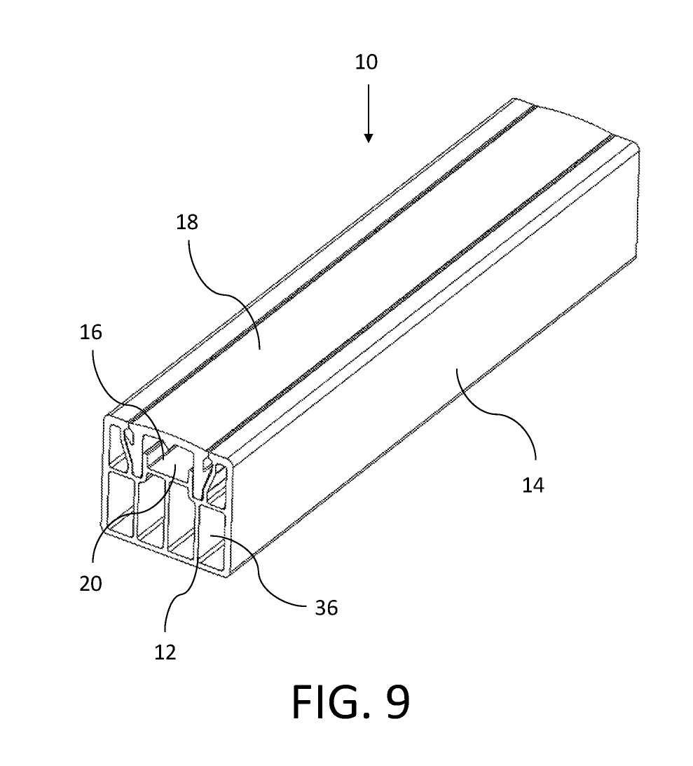

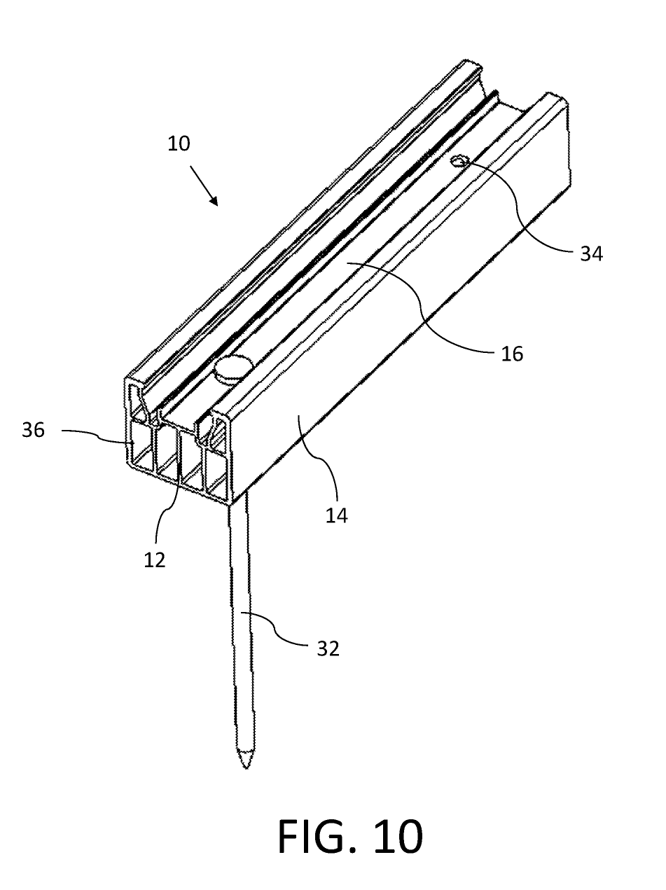

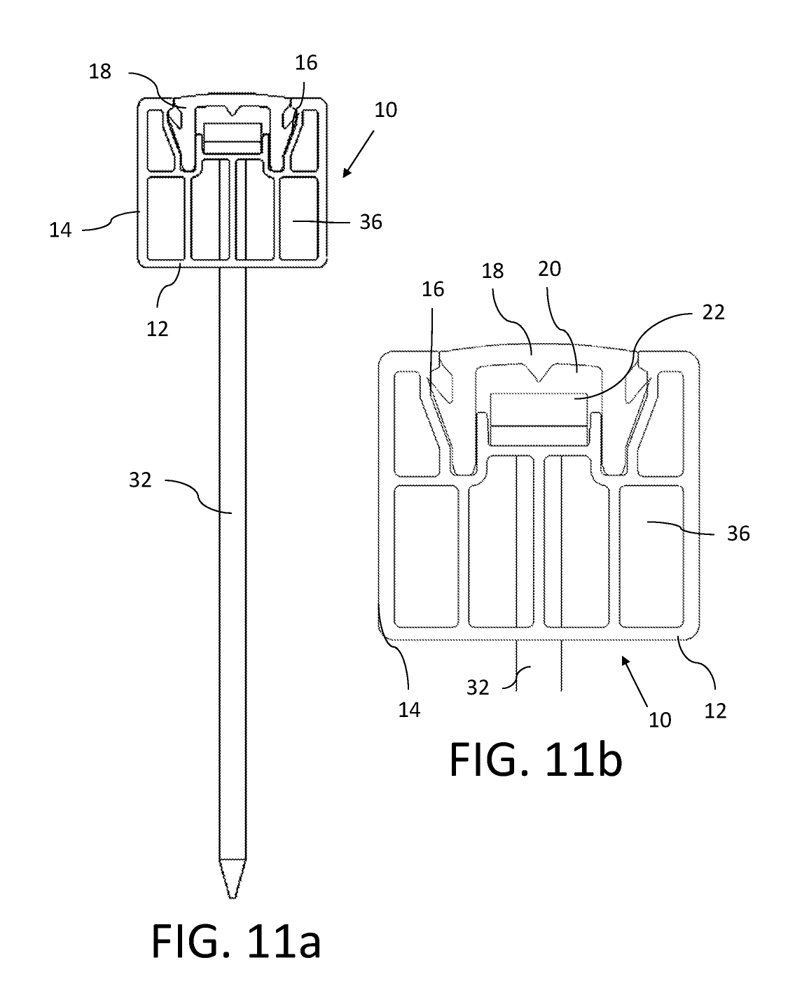

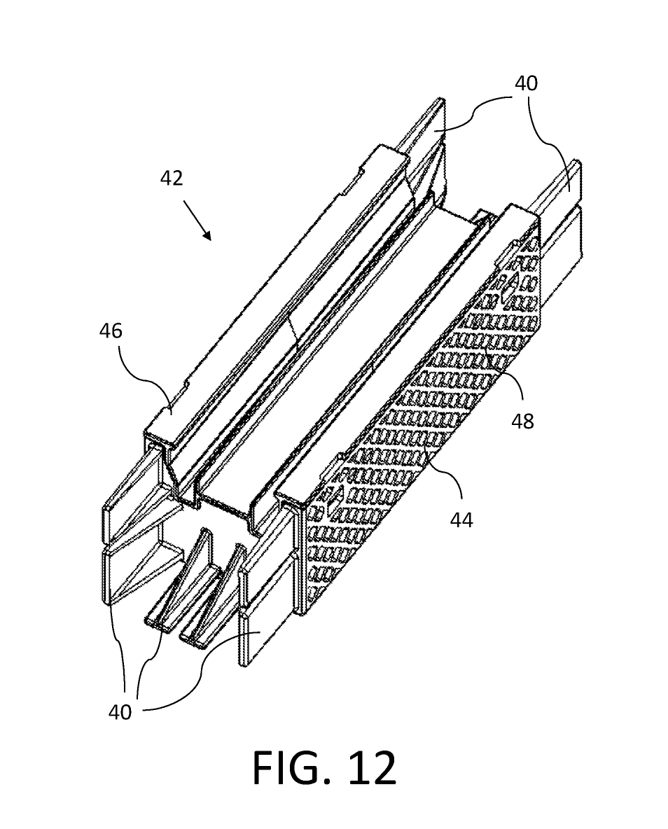

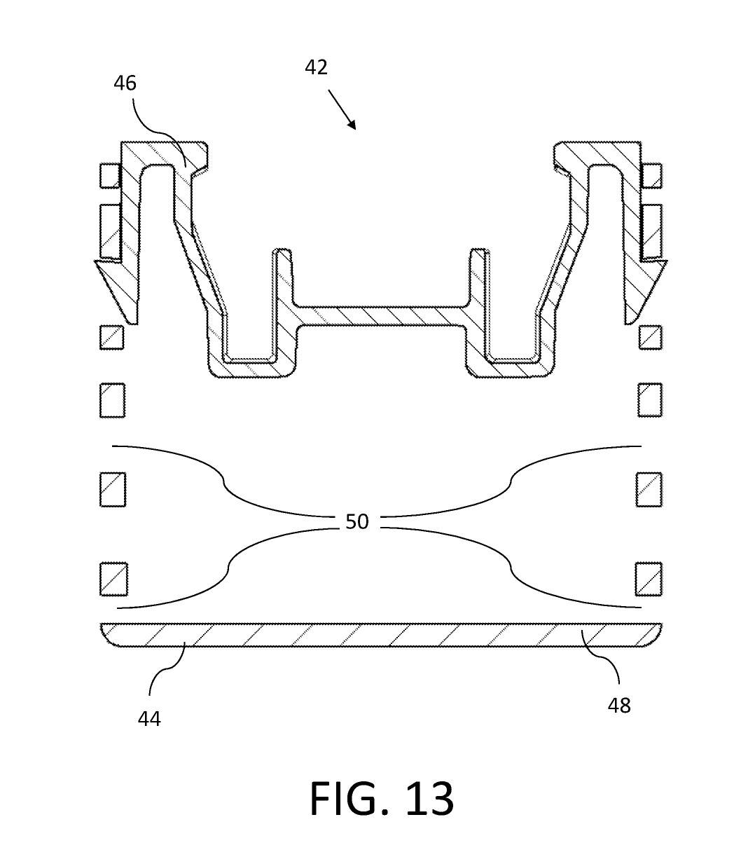

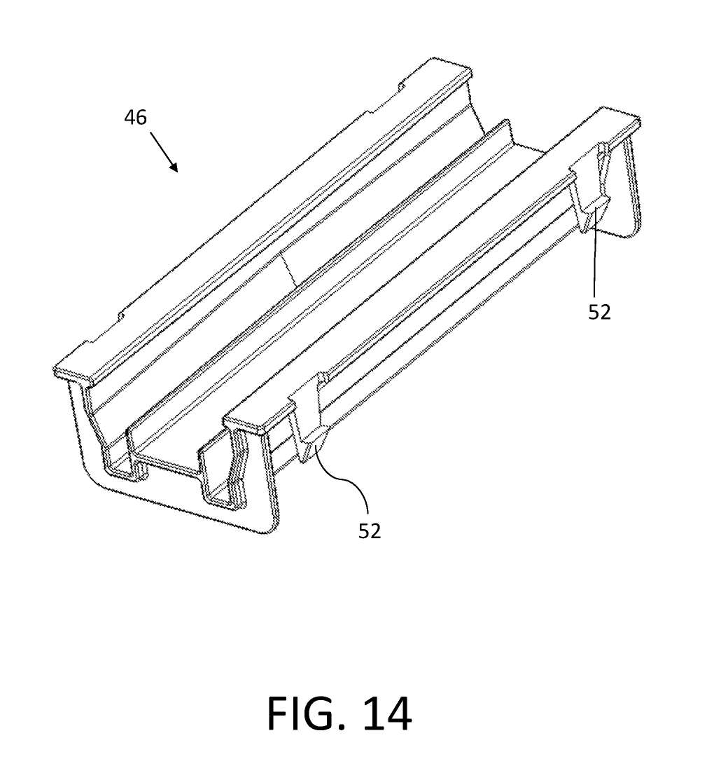

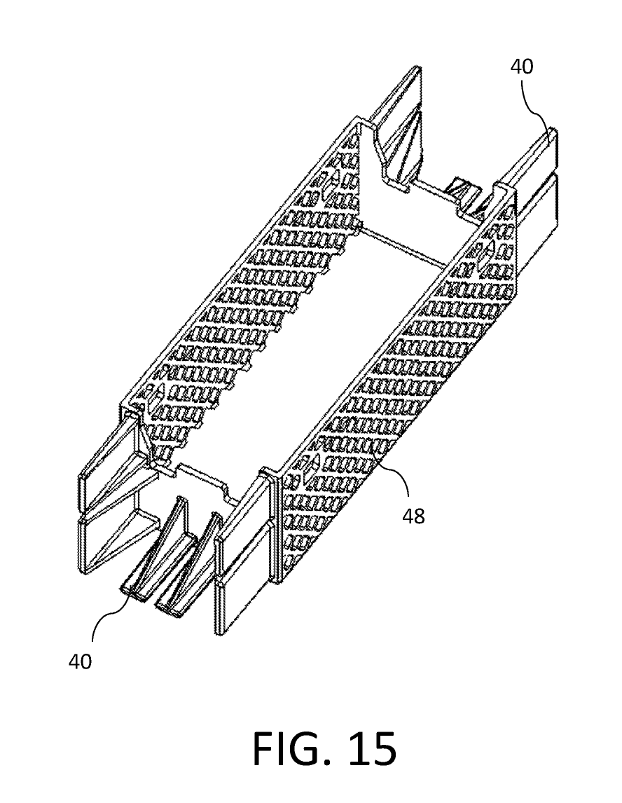

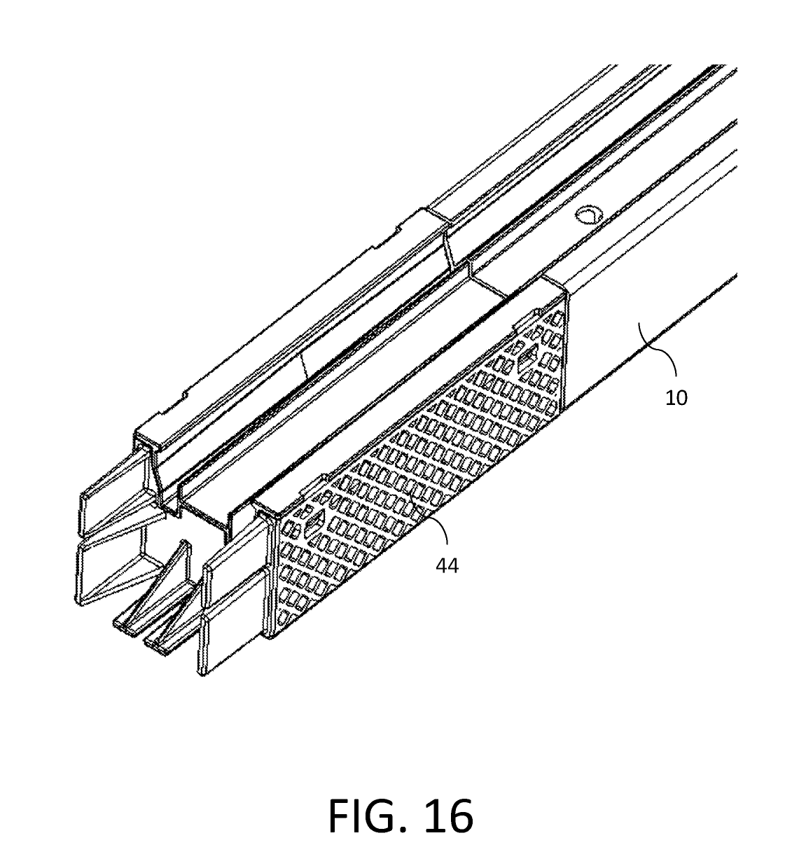

Referring to FIG. 9, body 10 has a base 12 which may be made from a flexible material. The flexible material is preferably PVC, however, as will be understood by those skilled in the art, other flexible materials such as rubber, plastics, etc. may also be used. As above, base 12 has a plurality of sides 14, one or more continuous lighting channels 16, lighting cover 18, continuous enclosure 20, and linear light source 22 (shown in FIGS. 11a and 11b). Referring to FIG. 6, body 10 has attachment openings 34, and referring to FIG. 10, body 10 may be fixed to the substrate by driving spikes 32 through base 12. As shown in FIG. 8, base 12 may be extruded or injection moulded with passages 36. Passages 36 may extend partially through the length of body 10, or may be continuous along the length of body 10. Passages 36 may provide structural strength to base 12, may decrease the weight of base 12, in comparison with a solid base. Passages 36 may also act as engagement openings to attach portions of body 10 together. Bodies 10 may be connected together in a variety of ways, as will be understood by those skilled in the art. Referring to FIG. 7a, bodies 10 may be connected together using connector 38. Connector 38 has engagement portions 40 that extend from either side of the connector, and may be inserted into passages 36 to connect lengths of body 10, as shown in FIG. 7b. Referring to FIG. 12, an alternate connector 42 may also be used to connect body 10. Alternate connector 42 also has engagement portions 40 that extend from either side of the connector, which are spaced apart by a drainage portion 44. As shown in FIG. 13, drainage portion 44 has a lighting channel portion 46 and a base portion 48. Base portion 48 has side openings 50 allowing fluid to flow through and exit drainage portion 44. Referring to FIG. 14 and FIG. 15, drainage portion 44 may be constructed in two portions that may be removably attached using connectors 52. Removing lighting portion 46 may, for example, allow for easy removal of debris from base portion 48. A drainage portion 44 connected to body 10 is shown in FIG. 16.

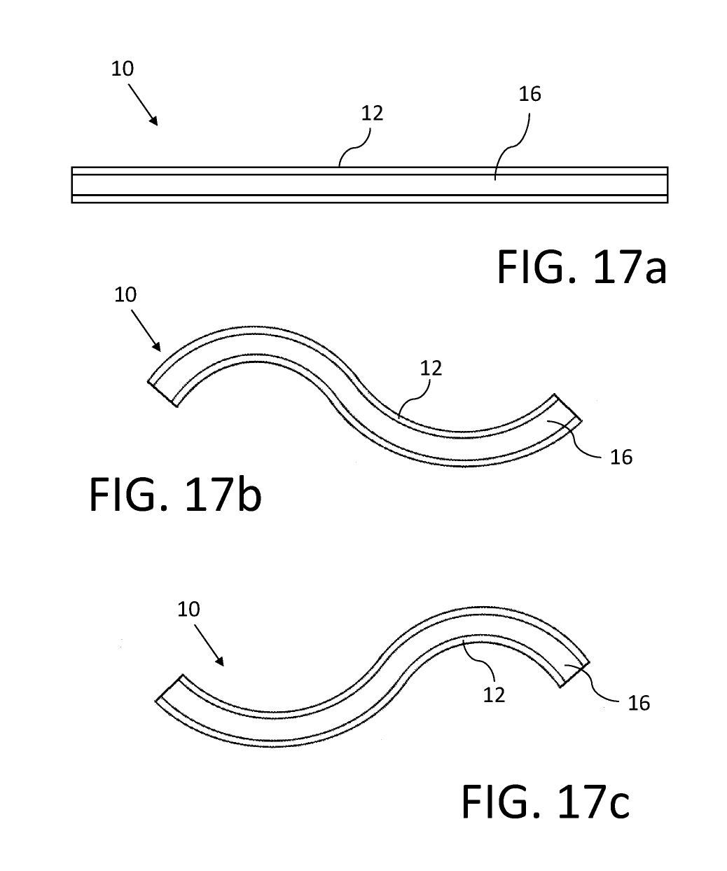

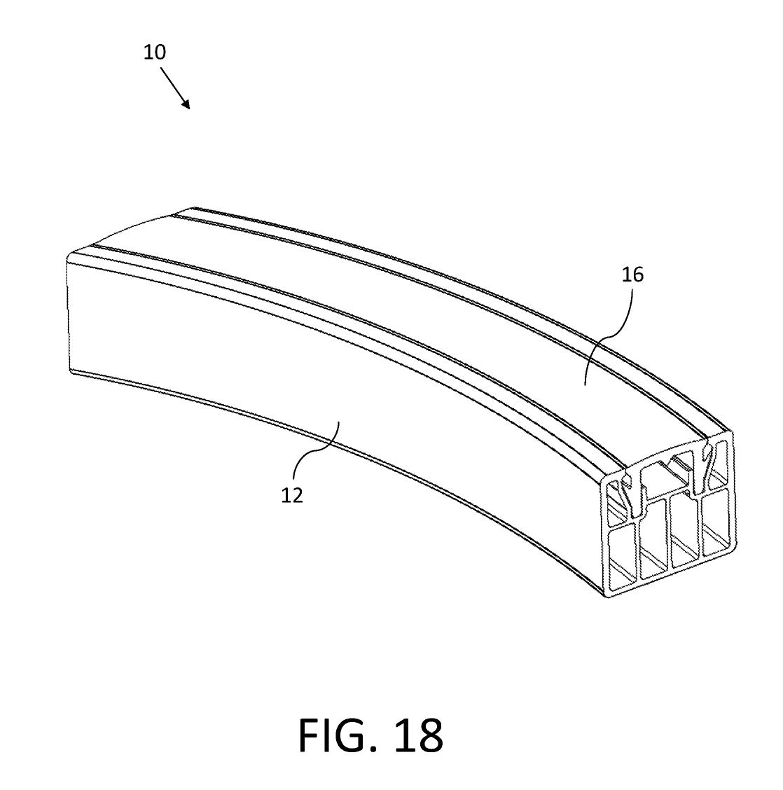

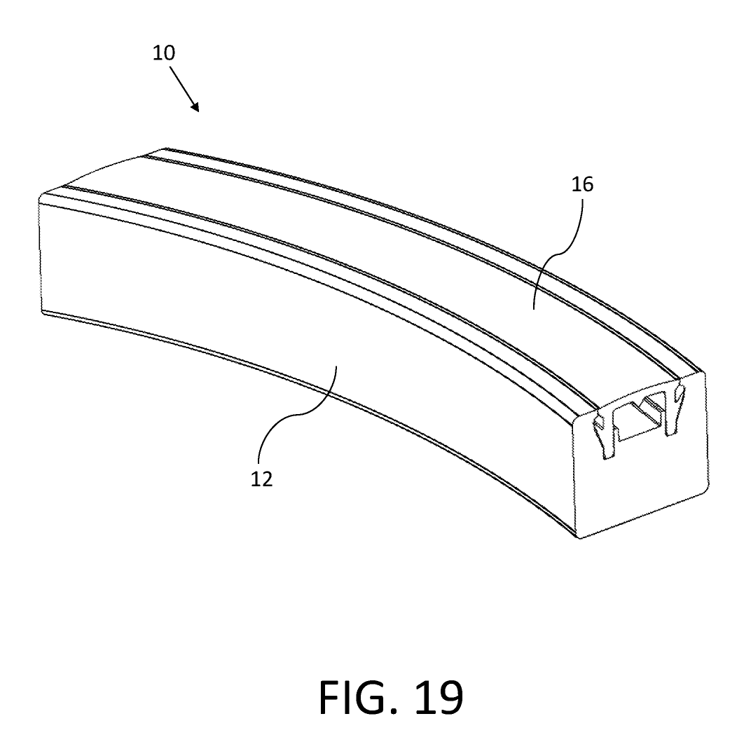

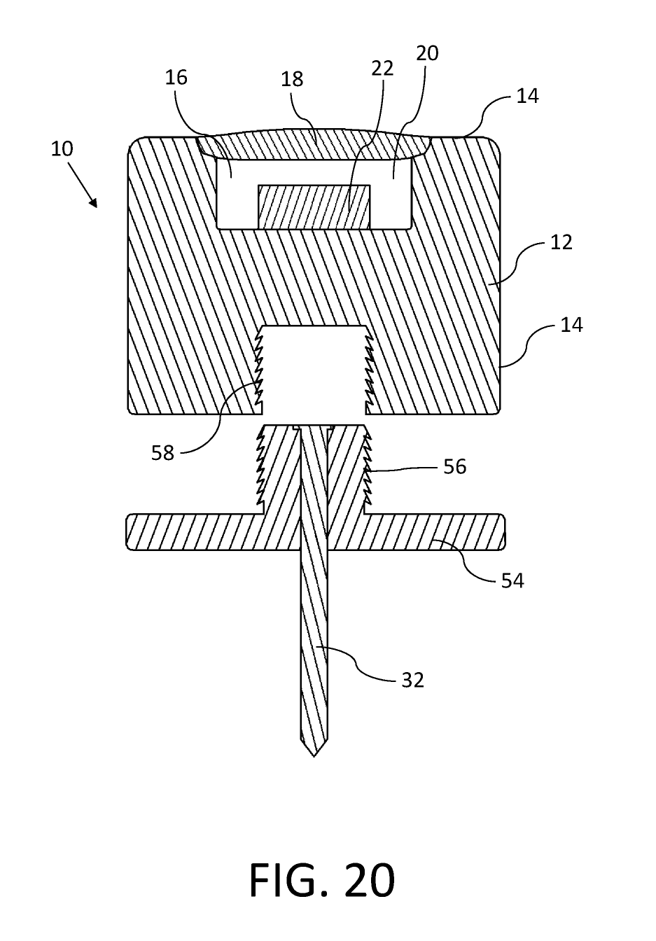

Referring to FIG. 17 through 19, as the body is flexible it is capable of being shaped in either a curved or a straight configuration. FIG. 17a shows a body that is straight, while FIGS. 17 b and 17c show the body being curved. As the body is flexible, this feature is found in all of the bodies having features as discussed. FIG. 18 shows a curved portion of the hollow body, while FIG. 19 shows a curved portion of the solid body.

Referring to FIG. 20, in some cases it may be necessary or desired to form body 10 such that the linear light source 22 is in a sealed enclosure. For example, this may be required with some types of lights, such as high voltage lights, when used in outdoor lighting applications to protect the lights against precipitation and moisture in the soil. In this case, the lighting cover 18 is provided in sealed engagement with base 12. This may be accomplished, for example, through the use of co-extrusion, adhesives, or other sealing means. Linear light source 22 is then inserted into enclosure 20 as shown. When spikes 32 or other anchors are used, base 12 may be provided with a platform 54 through which spikes 32 may be inserted. Base 12 may then be secured to platform 54 through use of an attachment 56 on platform 54 and a complementary attachment 58 on base 12, which allows enclosure 20 to remain sealed. As shown in FIG. 20, the attachment between 54 and 56 may be through use of complementary profiles that resist disengagement of base 12 from platform 54. The attachment between 54 and 56 may also be formed using a variety of other engagement profiles, as will be understood by those skilled in the art, as well as other fasteners including, for example, adhesive, clips, or bolts.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A body comprising:
a base made from a flexible material, the base having a plurality of sides and a length, one or more sides comprising a lighting channel formed in the base and having an opening in the one or more side, the lighting channel being continuous along the length of the base;
a lighting cover mounted toward the top of the base that forms an enclosure with the lighting channel; and
a linear light source enclosed within the enclosure and extending along at least a portion of the length of the base.

2. The body of claim 1, the base having a first end and a second end spaced apart by the length of the base, at least one of the first end and the second end comprising an opening extending at least a portion of the length of the base.

3. The body of claim 2, the body further comprising a connector inserted between one base and another base, the connector comprising engagement portions extending from the center of the connector and engaging the opening of each base.

4. The body of claim 3, the connector further comprising a drainage portion having a first end, a second end, a first side, and a second side, the engagement portions extending from at least one of the first end and the second end of the drainage portion, the drainage portion comprising drainage channels extending between the first side and the second side of the drainage portion.

5. The body of claim 1, wherein one or more sides comprise an engagement profile that engages a substrate.

6. The body of claim 1, wherein one of the sides is a bottom and the base portion comprises attachment openings between the lighting channel and the bottom, the attachment openings receiving spikes.

7. The body of claim 1, wherein the flexible material is one of rubber and polyvinyl chloride.

8. The body of claim 1, wherein the lighting cover is constructed from one of a transparent plastic and a translucent plastic.

9. The body of claim 1, wherein the light source comprises flexible linear LED lights.

10. The body of claim 1, wherein the enclosure is sealed along the length of the base.

11. An expansion joint for a layer of concrete, the expansion joint comprising:
a base made from a flexible material, the base having a length, atop, a bottom and opposed sides, the bottom and opposed sides comprising concrete engagement surfaces;
lighting channel formed in the base and having an opening at the top of the base, the lighting channel being continuous along the length of the base;
a lighting cover mounted toward the top of the base that forms an enclosure with the lighting channel; and
a linear light source enclosed within the enclosure and extending along at least a portion of the length of the base.

12. The expansion joint of claim 11, wherein the flexible material is one of rubber and polyvinyl chloride.

13. The expansion joint of claim 11, wherein the lighting cover is one of a transparent plastic and a translucent plastic.

14. The expansion joint of claim 11, wherein the light source comprises flexible linear LED lights.

15. The expansion joint of claim 11, wherein at least one of the opposed sides comprise an engagement profile that engages the concrete.

16. The expansion joint of claim 11, wherein the enclosure is sealed along the length of the base.

17. A method of providing an expansion joint with a continuous channel for lighting, the method comprising:
forming a layer of concrete;
before the concrete has cured, inserting an expansion joint into the concrete, the expansion joint comprising;
a base made from a flexible material, the base having a length, a top, a bottom and opposed sides, the bottom and opposed sides comprising concrete engagement surfaces;
a lighting channel formed in the base and having an opening at the top of the base, the lighting channel being continuous along the length of the base;
allowing the concrete to cure.
inserting a linear light source into the lighting channel; and
covering the lighting channel with a lighting cover.

18. The method of claim 17, wherein the flexible material is one of rubber and polyvinyl chloride.

19. The method of claim 17, wherein the lighting cover is one of a transparent plastic and a translucent plastic.

20. The method of claim 17, wherein the light source comprises flexible linear LED lights.

21. The method of claim 17, wherein at least one of the opposed sides comprises an engagement profile that engages the concrete.
